(19) United States
(12) Patent Application Publication
(10) Pub. No.: US 2014/0316857 A1
(43) Pub. Date: Oct. 23, 2014

(54) HOUSING PRICE ESTIMATOR

(71) Applicant: Lawrence Roberts, Irvine, CA (US)

(72) Inventor: Lawrence Roberts, Irvine, CA (US)

(21) Appl. No.: 13/939,116

(22) Filed: Jul. 10, 2013

Related U.S. Application Data
(60) Provisional application No. 61/814,721, filed on Apr. 22, 2013.

(51) Int. Cl. G06Q 30/02

(52) U.S. Cl. CPC G06Q 30/0206; G06Q 30/0205
USPC 705/7.34

(57) ABSTRACT

A method of valuing real estate properties includes the steps of calculating a premium or discount to rental parity for a historically stable time period and the current time period. Another method of timing a real estate market is also disclosed. Another method of searching for relevant property based on the personal income and/or expense of the buyer is also disclosed.

### CROSS-REFERENCE TO RELATED APPLICATIONS

This application claims priority to U.S. Prov. Pat. App. Ser. No. 61/814,721, filed on Apr. 22, 2013, the entire contents of which is expressly incorporated herein by reference.

### STATEMENT RE: FEDERALLY SPONSORED RESEARCH/DEVELOPMENT

Not Applicable

### BACKGROUND

The various embodiments and aspects disclosed herein relate to valuation of real property, a real property market timing system and a search function for real property.

The basics of real property valuation includes four different methodologies. These include (1) the sales comparison approach which is the common for residential real estate, (2) the capital asset pricing model, (3) the income approach, and (4) the cost approach.

The sales comparison approach for residential real estate reviews past sales of real properties which are similarly situated to the subject property being valuated within the past 1-3 months. By comparing past transactions to the instant transaction, this valuation model predicts the current likely transaction price of the subject property. However, since price of real property fluctuates up and down, this valuation model does not provide any sort of base value of the property.

The income approach is used to evaluate commercial properties. The income approach looks to the income that a real property will produce and compares that income to the up front money the investor must put into the property to determine ratios such as cap rates and cash flows to determine whether the property will meet the investor's investment objectives. This approach utilizes cap rates to determine the value of a property but does not provide any sort of base value of the property.

The cost approach assumes that real property is at a minimum worth the cost to replace the real property including any improvements. The capital asset pricing model compares real property as an investment to other forms of investments to determine the optimal vehicle for an investor.

These valuation models fail to provide a base value of real property. Accordingly, there is a need in the art for a method and system for valuing real property.

### BRIEF SUMMARY

The various aspects disclosed herein address the needs discussed above, discussed below and those that are known in the art.

The system and method disclosed herein compares historical real property sales transaction data for a stable period of time to the current market or subject property to determine the relative current market in relation to the historical norms. In doing so, the system and method downloads real property transaction data for both sales and rental data and correlates the sales and rental data to derive a cost ratio and/or a price ratio for the historically stable period of time. The cost and/or price ratio shows that a geographical region may transact at a premium or a discount from rental parity based on historical data for the stable period of time. This forms the base value of real property within a region about which the price of the real property (or subject property) will gravitate toward over a period of time regardless of whether the current market is transacting above or below the premium or discount. The system and method may then derive the cost ratio and/or the price ratio for the current market (e.g., past one month or past 3 months based on one month intervals). The current market may also show that the geographical region of interest is transacting at a premium or a discount from rental parity based on data from the current market. By comparing the current premium or discount to the premium or discount from a stable period of time, the current market/geographical region or real property at issue can be compared to the base value of real property to determines whether one is buying or selling above or below historical measures.

More particularly, a computer for downloading housing data and manipulating the housing data for presentation to the end user is disclosed. The computer may comprise an input port, an output port and a processor. The input port is connectable to one or more housing data sources. The output port is connectable to a communication means (internet, email, printer) to present the manipulated housing data to the one or more end users.

The processor may be loaded with software for performing the following step of determining a first ratio between a cost to own versus a cost to rent for a first time period. The determining the first ratio step includes the steps of downloading housing sales transaction data; filtering the downloaded housing sales transaction data based on a geographic limitation and the first time period; calculating the cost of ownership based on the filtered housing sales transaction data; downloading rental transaction data; filtering the downloaded rental transaction data based on the geographic limitation and the first time period; calculating the cost to rent based on the filtered rental transaction data; calculating a first cost ratio based on the calculated cost of ownership and the calculated cost to rent; presenting the first ratio to the end user.

The software loaded on the processor may further include the steps of determining a second ratio between a cost to own versus a cost to rent for a second time period. The determining the second ratio step includes the steps of downloading housing sales transaction data; filtering the downloaded housing sales transaction data based on a geographic limitation and the second time period; calculating the cost of ownership based on the filtered housing sales transaction data; downloading rental transaction data; filtering the downloaded rental transaction data based on the geographic limitation and the second time period; calculating the cost to rent based on the filtered rental transaction data; calculating a second cost ratio based on the calculated cost of ownership and the calculated cost to rent; presenting the second ratio to the end user.

The first time period may be a time period more than 1 year ago and the second time period may be a time period less than 1 year ago.

The steps of calculating the cost of ownership may include the step of calculating PITI and adjustments to PITI.

In another aspect, a computer for downloading housing data and manipulating the housing data for presentation to the end user is disclosed. The computer may comprise an input port, an output port and a processor. The input port is communicable to one or more housing data sources. The output port is connectable to a communication means (internet, email, printer) to present the manipulated housing data to the one or more end users.

The software loaded on the processor may further include the steps for performing the following steps of determining a first ratio between sales transaction data versus price at rental parity for a first time period; determining a second price ratio between a cost to own versus a cost to rent for a second time period; and presenting the first and second ratios to the end user.

The determining the first ratio step may include the steps of downloading housing sales transaction data; filtering the downloaded housing sales transaction data based on a geographic limitation and the first time period; calculating the sales transaction data based on the filtered housing sales transaction data; downloading rental transaction data; filtering the downloaded rental transaction data based on the geographic limitation and the first time period; calculating the price at rental parity base on the filtered rental transaction data; calculating a first price ratio based on the calculated cost of ownership and the calculated cost to rent.

The determining the second ratio step may include the steps of downloading housing sales transaction data; filtering the downloaded housing sales transaction data based on a geographic limitation and the second time period; calculating the cost of ownership based on the filtered housing sales transaction data; downloading rental transaction data; filtering the downloaded rental transaction data based on the geographic limitation and the second time period; calculating the cost to rent based on the filtered rental transaction data; calculating a cost ratio based on the calculated cost of ownership and the calculated cost to rent.

In another aspect, a method for searching for real estate properties is disclosed. The method may comprise the steps of receiving a plurality of first inputs regarding personal information of an internet user; receiving a plurality of second inputs regarding real estate criteria on desired real estate properties; calculating a cost to own for each individual property within a real estate data set; associating the cost to own to each individual property; calculating an affordability level of the internet user based on the first inputs; filtering the data set of real estate properties to only those properties that match the second inputs and the affordability level of the internet user; and presenting the filtered data set of real estate properties to the user through a website.

In the method, the personal information may include one or more income, expenses, assets and loan type. In the method, the real estate criteria may include one or more of square footage, lot size, number of bedrooms, view, location, number of baths, parking, year built, garage and property type. In the method, the cost to own is calculated by computing PITI and adjustments to PITI. In the method, the affordability level may take into account a desired loan type including one or more of FHA, 30 year fixed, adjustable rate mortgage.

In another aspect, a method for rating real estate is disclosed. The method may comprise the steps of downloading real estate transaction data for rental and resale of real estate properties; assigning a market valuation rating based on real estate transaction prices for a current market compared to real estate transaction prices for a predetermined historical period of time; assigning a resale rating based on a rate of rising or falling prices of real estate properties; assigning a rental rating based on a rate of rising or falling rents; summing the calculated market valuation rating, resale rating and rental rating; and presenting the summed ratings to an internet user via a website, paper document, electronic document or email.

In the method, the assigning the market valuation rating step may include the steps of calculating a premium or discount of resale prices of real estate properties compared to rental parity for the predetermined historical period of time; calculating a premium or discount of resale prices of real estate properties compared to rental parity for the current market; and assigning the market valuation rating based a difference between the calculated premiums or discounts for the predetermined historical period of time and the current market.

In the method, the assigning the resale rating step may include the steps of calculating a year-over-year change in resale dollars-per-square-foot price utilizing an average of a prior six month's data; and assigning the resale rating based on the calculated resale year-over-year change.

In the method, the assigning the rental rating step may include the steps of calculating a year-over-year change in rental dollars-per-square-foot price utilizing an average of a prior six month's data; and assigning the rental rating based on the calculated rental year-over-year change.

In the method, the real estate transaction data may be for a particular state, city, community or custom geographical region.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a graph of cost ratio as a function of time for real property;

FIG. 2 is a graph of price ratio as a function of time for real property;

FIG. 3 is a schematic of server downloading raw real property data from data feed sources and presenting converted data to users;

FIG. 4 is a graph of price of real property as a function of time with a plot of rental parity value;

FIG. 5 is a graph of rent of real property as a function of time with a plot of rental parity rent;

FIG. 6 is a heat map for real property;

FIG. 7 is a tabular presentation of the price ratio or the cost ratio;

FIG. 8A is a flow chart for determining a cost ratio; and

FIG. 8B is a flow chart for determining a price ratio.

### DETAILED DESCRIPTION

Referring now to the drawings, a computer system 10 and method for (1) valuing real property (e.g. residential or commercial) for a particular region or individual properties within the particular region based on a historical discount or premium to rental parity 16 compared to current transaction sale prices and current market rents for the particular region and/or individual properties and (2) presenting such information to interested parties (e.g. buyers and sellers) 14 are shown and discussed. The computer system 10 downloads real property transaction data from one or more data feed sources 12. The computer system 10 filters the real property transaction data in order to determine a cost ratio between a cost of ownership and a cost to rent. Alternatively or additionally, the computer system 10 filters the real property transaction data in order to determine a price ratio between an actual transaction price and a price at rental parity 16 (i.e., rental parity value). The ratios may be to compare a historically stable time for real property transactions and the current market or a subject property. These ratios may be presented to interested parties 14.

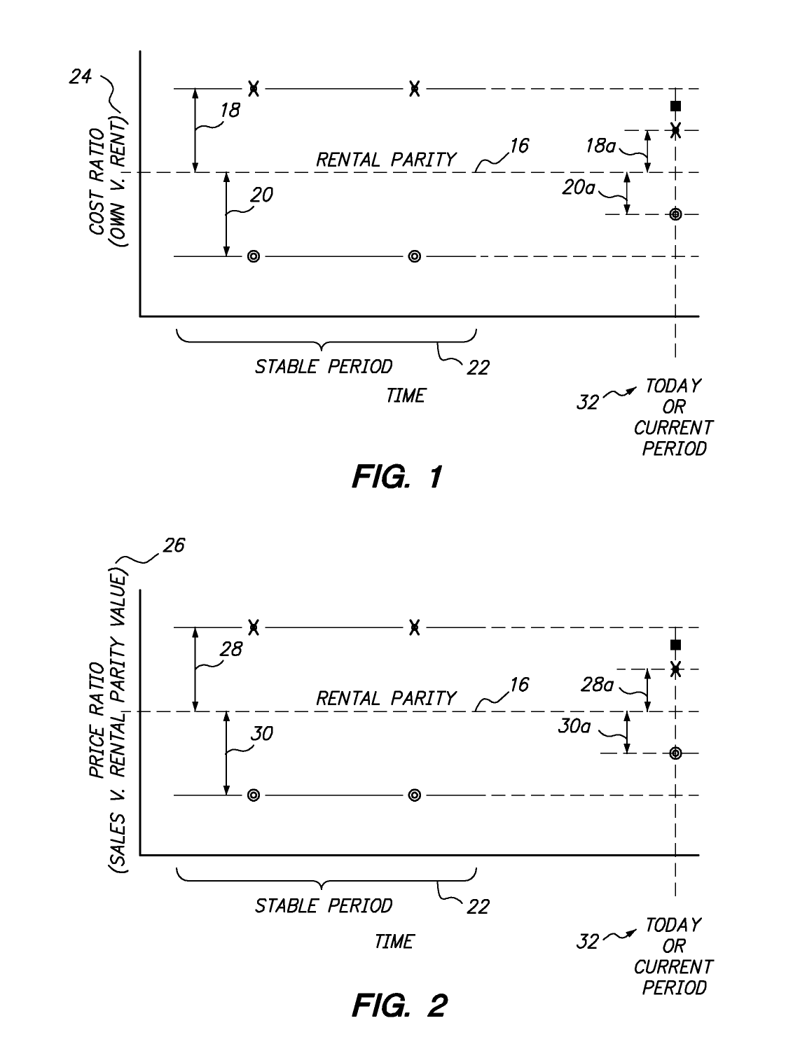

Referring now to FIG. 1, a graph of cost ratio 24 as a function of time is shown. When the cost to own is equal to the cost to rent a real property, the decision to buy or rent is at rental parity 16. However, real property within a particular region may sell at a premium 18 above rental parity 16 or at a discount 20 below rental parity 60. As such, it is misleading to decide value solely on rental parity. The computer system 10 also downloads the real property transaction data 12 and determines the premium 18 or discount 20 for a stable period of time 22 which reflects normal market conditions. The computer system 10 also downloads the data 12 and determine premium 18a or discount 20a for the current period of time 32. For example, real properties in the region associated with the x dot data in FIG. 1 are currently transacting below their historical premium 18 within the stable period of time 22. As such, this region is undervalued even though the real properties in the region are transacting above rental parity 16. In other words, real properties in this region are undervalued based on historical norms. For real properties in the region associated with the circle dot data, such real properties are transacting below rental parity 16 but are still transacting above the discount 20 during the stable period of time 22. As such, the real properties are overvalued based on historical norms. Accordingly, the computer system for valuing and method associated therewith determines real property values compared to historical norms.

Referring now to FIG. 2, a graph is shown which illustrates a price ratio 26. The price ratio 26 is an alternate embodiment or method to the cost ratio shown in FIG. 1 for valuing and indicating whether real properties are currently undervalued or overvalued with respect to the stable period of time 22. When a sales transaction price is equal to a rental parity value, the decision to buy or rent is at rental parity 16. Rental parity value is a calculated value of a real property based on the rental value of a similarly situated real property. It is a calculated price of real property based on the assumption that the cost to own equals to the cost to rent. Real properties within a particular region may sell at a premium 28 or at a discount 30 to rental parity value during a stable market period. The computer system 10 downloads the data 12 and determines the premium 28 or discount 30 for a historical stable period of time 22 which reflects normal market conditions. The computer system 10 downloads the data 12 and determines the premium 28a or discount 30a for the current period of time 32. For real properties in the region associated with the x data, such real properties are currently transacting below their premium 28 within the stable period of time 22. As such, this region is undervalued even though the real properties in the region are currently transacting above rental parity value. In other words, the real properties in this region are currently undervalued based on historical norms. For real properties in the region associated with the circle data, such real properties are transacting below rental parity but are still acting above the discount 30 within the stable period of time 22. As such, the real properties are overvalued based on historical norms. In other words, real properties in this region are currently overvalued based on historical norms.

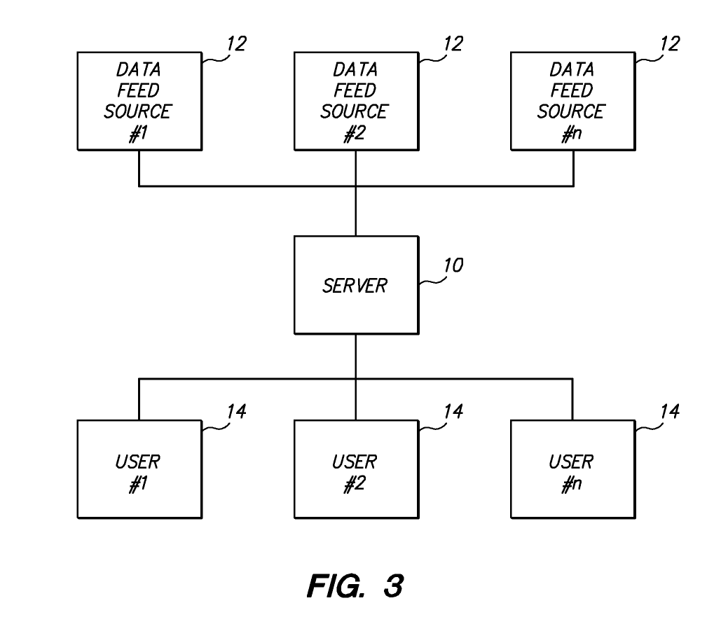

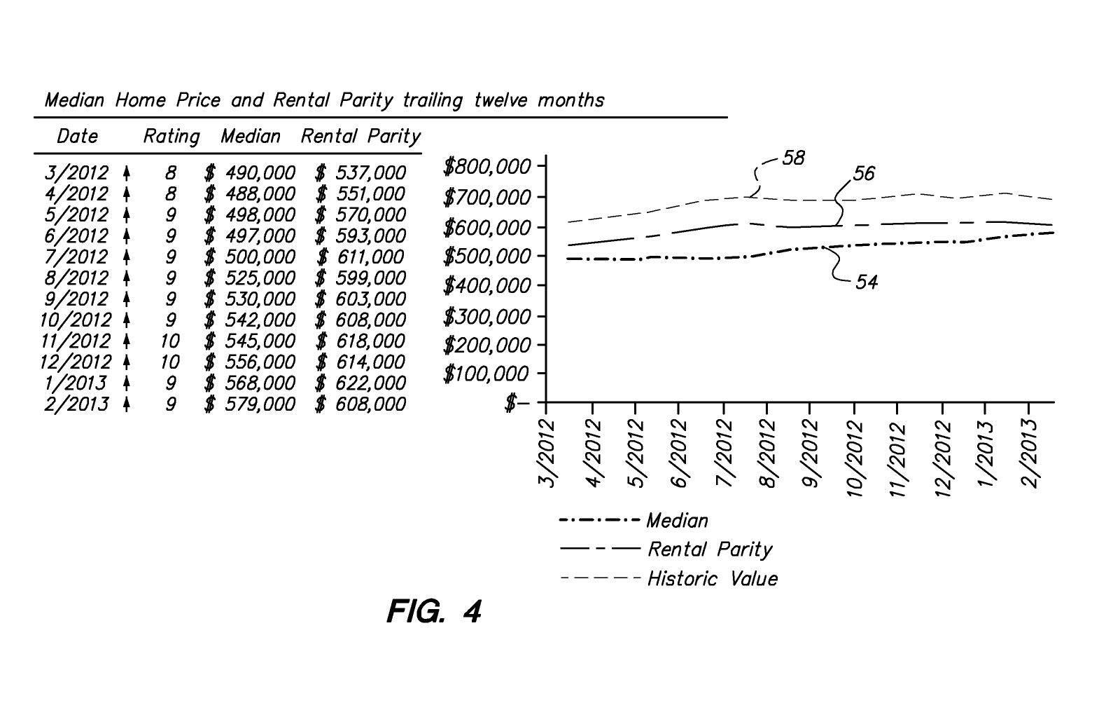

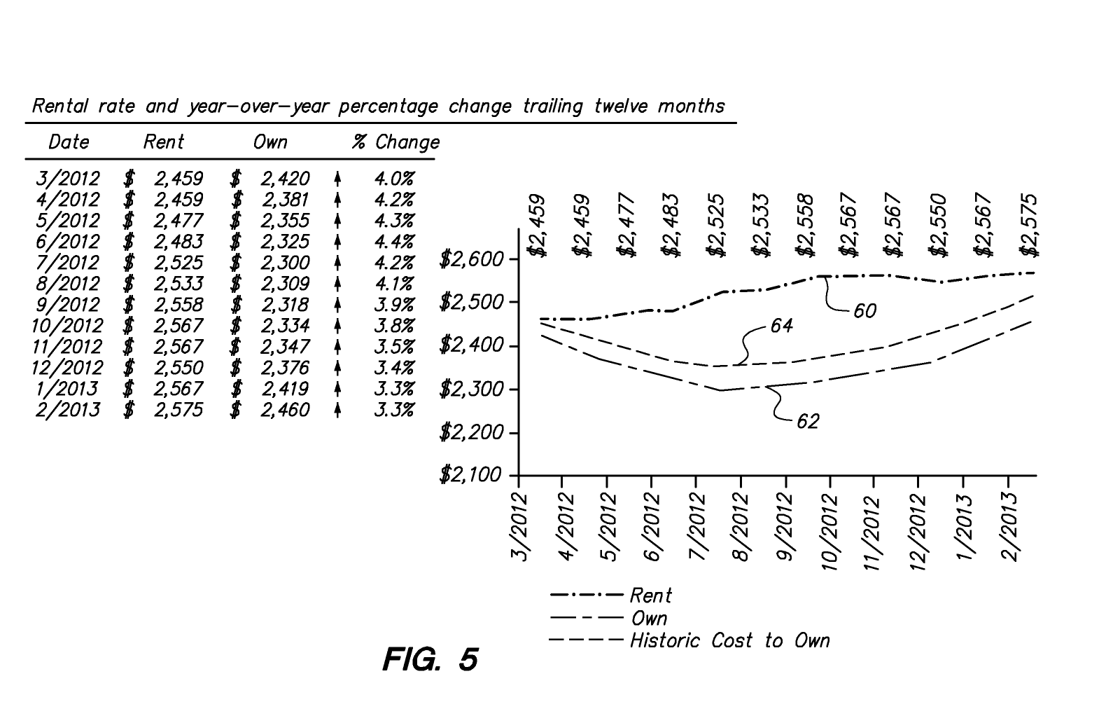

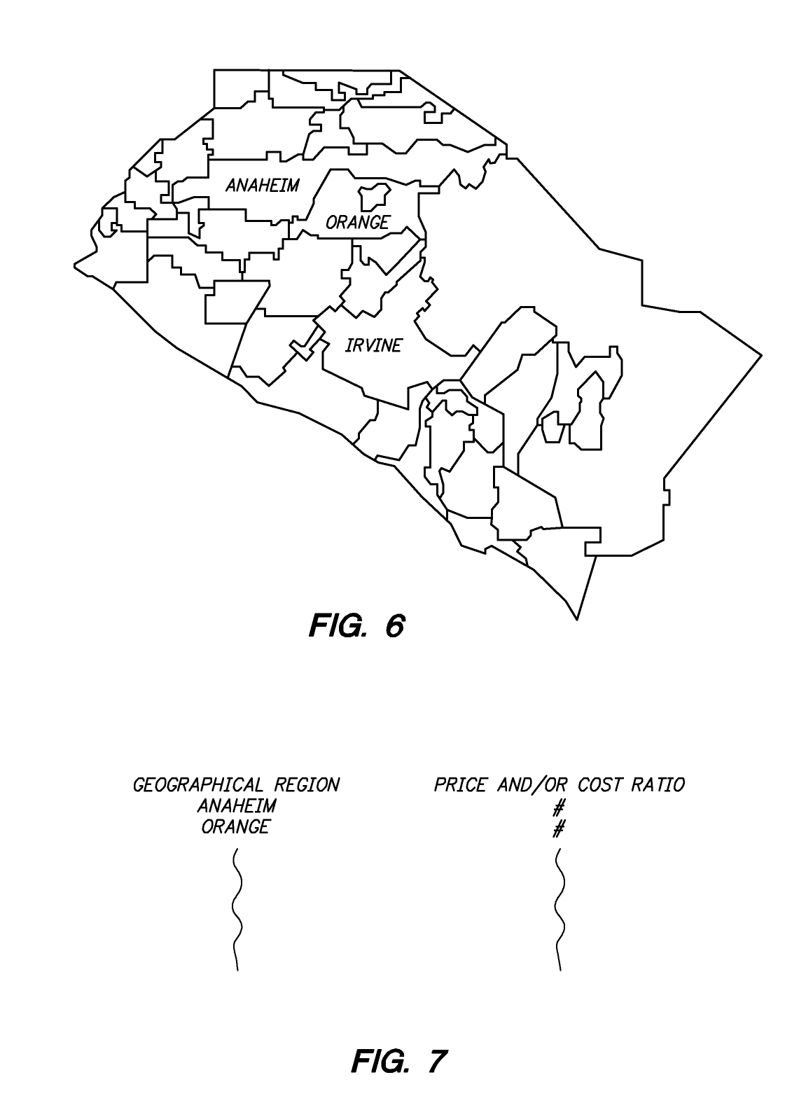

Referring now to FIG. 3, the computer system 10 is shown as being in communication with one or more data feed sources 12 for downloading data to the server 10. These data sources 12 provide the computer system 10 with the real property transaction data. The real property transaction data is processed through the computer system 10 which outputs the cost ratio 24 and/or the price ratio 26 in one or more various formats to users 14. These formats may include a graph of the cost ratio 24 as a function of time (see FIG. 1), a graph of the price ratio 26 as a function of time (see FIG. 2), a graph of rental parity value 58 as a function of time (see FIG. 4), a graph of rental parity rent 64 as a function of time (see FIG. 5), a color-coded heat map (see FIG. 6) of a number of geographical regions, and/or a list of graphical regions (see FIG. 7).

The real property transaction data may be downloaded or received from one or more data sources 12. The real property transaction data may include and is not limited to (1) residential and commercial buildings transaction sales and (2) residential and commercial buildings rental contracts. The data included in residential and commercial building transaction sales may include sales price, building square footage, type of building (residential or commercial), lot size and other information. The data included in residential and commercial building rental contracts may include rental rate, building square footage, type of building (residential or commercial), lot size and other information. The various aspects and embodiments disclosed herein may be applicable to acquiring raw real property transaction data, converting such raw real property transaction data to compare market conditions for the current time period and a stable period of time in the past and presenting the converted data and such comparisons to end users or interested parties 14 for commercial and/or residential real properties. The figures and embodiments and examples provided herein are specifically tailored to residential real property. Nonetheless, the various teachings and aspects may also be applied to commercial real property.

After receiving the real property transaction data into the computer system 10, the computer system 10 is loaded with software for performing the following steps to calculate the cost ratio 24 for the stable period of time 22. In particular, housing sales data 34 and housing rental data 36 are filtered from the real property transaction data 12. For the housing sales data, 34, a geographical filter 38 and the time filter 40 are applied.

The geographical filter 38 may be based on country, state, city, community, or custom geographical boundary such as those areas defined by local multiple listing service data providers. The size and configuration of the geographical filter can vary widely. The smaller and more homogeneous the market is, the more the results represent the activity. However, if the market area is defined in such a way that the total number of transactions analyzed during any given period are too small, the results become volatile and thereby less useful and accurate. Defining a geographical boundary either through predetermined measures (e.g. country, state, city, zip code, etc.) or a custom geographical boundary is a balance between narrowing the area to be representative of market activity and broadening the area to obtain enough transaction data to avoid excessive volatility. The geographical filter is sized and configured to yield a statistically relevant sample size.

The time filter 40 to determine a stable period of time is modified to consider only a period of time representative of a normal and stable market by defining the time so that only normal and stable periods of time are included and abnormal market conditions and transaction data are excluded. By way of example and not limitation, real property bubbles in California existed from 1976 to 1982 and from 1987 to 1992. These should be excluded from analysis for California. Additionally, the United States experienced a housing bubble from 2003 to 2009. This period should also be excluded from all geographical regions. For the purposes of illustration, the time filter 40 filters the data to provide transaction data from the period from 1993 to 1999. However, other time periods may also be used.

A normal market for real estate is characterized by a stable relationship between rent and cost of ownership. The ratio between these two in a stable market shows very little variability in that any premium or discount above or below rental parity is maintained within 15%, and more preferably within 10%. Moreover, any imbalances are quickly corrected within two years, and more preferably, one year. Prices are neither too high nor too low relative to rents for long periods in a normal market. These factors may be programmed as filters in the computer to determine the time filter 40.

After filtering the real property transaction data 12 to include only housing sales data 34, and applying the geo filter 38 and the time filter 40 as discussed above, a subset of housing sales data 34 remains. The cost of ownership 42 is now calculated based on the subset of housing sales data 34. To determine the cost of ownership, either the median transaction price or the average of the transaction prices of the subset of housing sales data 34 is used. The illustrations provided herein utilize the median transaction price but it is also contemplated that the average transaction price based on the subset of housing sales data 34 may also be utilized. To determine the cost of ownership based on the median transaction price, the PITI 44 is calculated and adjustments 46 to PITI 44 are also calculated. The resultant number (i.e., PITI 44 plus PITI adjustments 46) is the cost of ownership 42.

PITI 44 stands for principal, interest, taxes and insurance. This PITI 44 represents the sum of monthly mortgage payment, property tax, special taxes and levies, homeowners insurance, mortgage insurance, and the homeowner's association fees. Although the monthly mortgage payment varies based on financing options, fixed 30 year financing with 20% down has been a stable financing option since its inception. As such, the monthly mortgage payment is calculated based on a fixed 30 year financing with 20% down based on the financing interest rate for the period of time applied by the time filter 40. The monthly mortgage payment includes the principal and interest portion of PITI 44.

Since property taxes vary considerably by region, the specific tax rate for the geographical region applied to the geographical filter 38 is used. Computing the monthly property tax burden is based on the formula of property tax equals property cost basis times property tax rate divided by 12. By way of example and not limitation, for California, the tax rate of 1.04 may be used to determine or estimate the property tax. Each jurisdiction may have its own property tax rate which must be determined either on an individual basis or calculated as an average or median for a geographical region. In addition to property tax, certain jurisdictions impose special taxes and levies which may be evaluated for specific properties or estimated for a specific geographical region. By way of example and not limitation, California has Mello-Roos taxes. This tax rate was fixed by the developer when the subdivision was permitted. This information can be obtained for any property from the local assessor's office. An estimate of Mello-Roos taxes for California is 0.08 times property cost basis for real properties constructed in 2002 or later. If the real property was constructed between 1994 and 2002, the estimate of Mello-Roos is equal to the property cost basis times 0.04. If the real property was constructed between 1985 and 1994, the Mello-Roos is calculated as the property cost basis times 0.01. Each jurisdiction may have its own special taxes and levies which must be determined either on an individual basis or calculated as an average or median for a geographical region.

Homeowners insurance rates vary widely but an average estimate may also be used. Currently, the average estimate is about $25 for each $100,000 home price.

Homeowners association fees also vary widely. Real estate transaction data may not include this data. In such cases, either a median value or an average value may be manually determined from the subset of housing sales data 34.

PITI 44 is calculated as the sum of the above determined costs. After calculating the PITI 44, adjustments (i.e., subtractions and additions) to PITI 44 are also made in order to determine the monthly cost of ownership. These adjustments include tax savings (a negative value which is subtracted from PITI 44), loan amortization (a negative value subtracted from PITI 44), lost opportunity cost of the down payment which is added to PITI 44 and the lost opportunity cost of required maintenance and replacement reserves which is also added to PITI 44. Based on the period of time applied to the time filter 40, the average tax savings based on federal and state tax rules are calculated. In particular, federal tax savings are calculated as net tax savings=(−1×(gross tax savings x marginal tax rate)). Gross tax savings equals property taxes plus mortgage interest plus mortgage insurance minus the standard deduction. All values are converted to monthly amounts. Property tax equals property cost basis times property tax rate divided by 12 (property cost basis and property tax rate are defined in the PITI 44 calculations). Mortgage or loan interests are equal to loan balance times interest rate divided by 12. The marginal tax rate and standard deduction may be taken from IRS tax tables. The standard deduction must also be divided by 12 to arrive at a monthly value.

State tax savings are also calculated. Because state and federal taxes are sometimes based on different standard deduction, different tax brackets, and different tax rates, state and federal tax savings must be evaluated independently and added together to determine the total tax saving for the particular geographical region or property. By way of example and not limitation, monthly state tax savings may be computed as follows: net tax savings=(−1×(gross tax savings x marginal tax rate)). Since this is a savings and not a cost, the result of this calculation is converted to a negative number. Hence, the −1. If the net tax savings is greater than 0, then the net tax savings equals 0. This value cannot be positive. For California, the standard deduction is currently $7,682 per year. This number is divided by 12 to determine the monthly deduction.

Gross tax savings equals property taxes plus mortgage interest plus mortgage insurance minus the standard deduction. All values are converted to monthly amounts. Property tax equals property cost basis times property tax rate divided by 12 (property cost basis is defined in the PITI 44 calculations). Loan interest equals loan balance times the interest rate divided by 12. The marginal tax rate may be taken from the California franchise tax board tax tables. Income is calculated from PITI 44 in the following manner. Income equals PITI 44 divided by 0.31 times 12. The 0.31 number represents a 31% debt to income ratio which is the current limit on FHA (Federal Housing Administration) and GSE (Government Sponsored Enterprises such as Freddie Mac and Fannie Mae) loans but is subject to change the in future. The 31% debt to income ratio is an adjustment of gross income to calculate the total amount available for house payments in PITI. If income is less than $14,240 the marginal tax rate equals 0.01. If income is less than $33,780 and greater than or equal to $14,248, then the California marginal tax rate equals 0.02. If income is less than $53,314 and greater than or equal to $33,780 then the California marginal tax rate equals 0.04. If income is less than $74,010 and greater than or equal to $53,314 then the California marginal tax rate equals 0.06. If income is less than $93,532 and greater than or equal to $74,010 then the California marginal tax rate equals 0.08. If income is less than $2 million and greater than $93,532 then the California marginal tax rate equals 0.093. If income is greater than $2 million then the California marginal tax rate equals 0.103.

The loan amortization portion of the PITI adjustment 46 represents a forced savings account. A mortgage payment is part interest payment and part principal repayment. In effect the principal repayment is the forced savings account. The portion of the mortgage payment representing the principal repayment is not a cost added to the cost of ownership because the owner will obtain the future benefit of this money. To calculate loan amortization, the following formula is utilized in a common spreadsheet application (e.g., Excel by Microsoft and Numbers by Apple). Conventional loan amortization equals conventional payment minus conventional loan interest. Conventional payment is equal to the formula P=−1×{L[c(1+c)ⁿ]/[(1+c)ⁿ−1]}. L is the loan amount. n is the number of months. c is interest rate on a monthly basis. Since monthly payment is not a cost and is a savings, the result of this calculation is converted to a negative number. The formula is represented as P=−1×PMT(C, M, L) where C is usually divided by 12 and M is multiplied by 12 to return a monthly payment. Conventional loan interest equals conventional loan balance times conventional interest rate divided by 12.

PITI adjustment 46 also includes adjustments for opportunity cost of down payment. Money put into a down payment on a house could have been invested in alternative investment options. This creates an opportunity cost representing lost income on the money saved for the down payment. Since most people save for down payments in conservative short-duration interest-bearing accounts, an estimation of short-term certificate of deposit rates is used. Since interest rates and short-term deposits are loosely correlated to mortgage interest rates, the calculations to determine the lost opportunity cost of down payment is correlated with the mortgage interest rate. By way of example and not limitation, conventional lost income=conventional down payment×[conventional interest rate−(conventional interest rate/3+0.01)]. This is one method of calculating the lost opportunity but other methods known in the art or developed in the future are also contemplated.

Real property requires routine maintenance. Lost opportunity costs are also calculated for maintenance and replacement reserve funds. Further, over time, more expensive items such as roofs and exterior paint need replacement. Budgeting for the irregular expenses of routine maintenance and the slow depletion of wear and tear requires establishing a monthly allowance for maintenance and replacement reserves. Conventional maintenance and replacement reserves equal property cost basis times 0.003 divided by 12 plus 20. The cost of ownership is calculated based on PITI 44 and adjustments 46 made to PITI 44 to come up with a monthly cost of ownership for the median property.

To calculate the ratio of cost of ownership to cost to rent, the cost to rent must be determined. In order to do so, housing rental data 36 is separated from the real property transaction data 12 in the computer system 10. The same geographical filter applied to the housing sales data is also applied to the housing rental data. Also, the same time filter 40 applied to the housing sales data is also applied to the housing rental data. The median housing rental data may be utilized or the average of the housing rented data may be utilized to determine the cost to rent. For individual properties, cost of ownership can be estimated accurately through the calculations above. The adjustments to PITI 44 vary widely by property and no accurate method exists to aggregate these for a large region. However, the adjustments to PITI 44 can be estimated for a region. In particular, the median resale price for the area may be inserted into the loan payment formula and the computed loan payment value may be accepted as a monthly cost of ownership. This estimate encompasses all of the costs of ownership calculations of PITI 44 and adjustments 46.

The following formula is used to calculate the estimated monthly cost of ownership required to fully amortize a loan of L dollars (where the median resale price is substituted for a loan amount) over a term of n months at a monthly interest rate of c. [If the quoted rate is 6%, for example, c is 0.06/12 or 0.005]0.360 periods is used.

Estimated Monthly Cost of Ownership=L[c(1+c)n]/[(1+c)n−1]×Adjustment Factor

The formula for Microsoft Excel is as follows: Estimated Monthly Cost of Ownership=[PMT(c, n, L)×Adjustment Factor] where c is usually divided by 12 and n is multiplied by 12 to return a monthly cost of ownership.

From empirical analysis with hundreds of properties, it has been determined that the base calculation of rental parity does not match the cost of ownership for individual properties without an upward adjustment factor. This factor can range between 5% and 20% due to the variable costs in PITI of homeowners association dues and special taxes and levies. For purposes of these calculations an adjustment factor of 6% is used as this is a typical amount on most properties without HOAs or Mello Roos taxes.

Adjustment Factor=1.06

Since most properties with HOAs and Mello Roos were constructed more recently, an adjustment factor for properties that have HOAs and Mello Roos may be determined and based on the average age of properties within a specified area. However, when new construction is added to an older resale stock, the average age adjustment will upwardly distort rental parity values for the old stock. This must be taken into consideration when determining the adjustment factor due to HOAs and Mellos Roos and the like.

Empirical evaluation over a large number of properties reveals this estimation (6% or 1.06) to be acceptably close to more accurate calculations for individual properties. Further, uniform application of this formula yields consistent results across a variety of markets.

The cost of ownership may be compared to the cost to rent to derive a cost ratio between these two costs. The ratio reflecting the premium or discount with respect to rental parity may be calculated as [(cost of ownership minus cost to rent) divided by cost to rent]. A positive number reflects a premium 18 and a negative number represents a discount 20 with respect to rental parity 16.

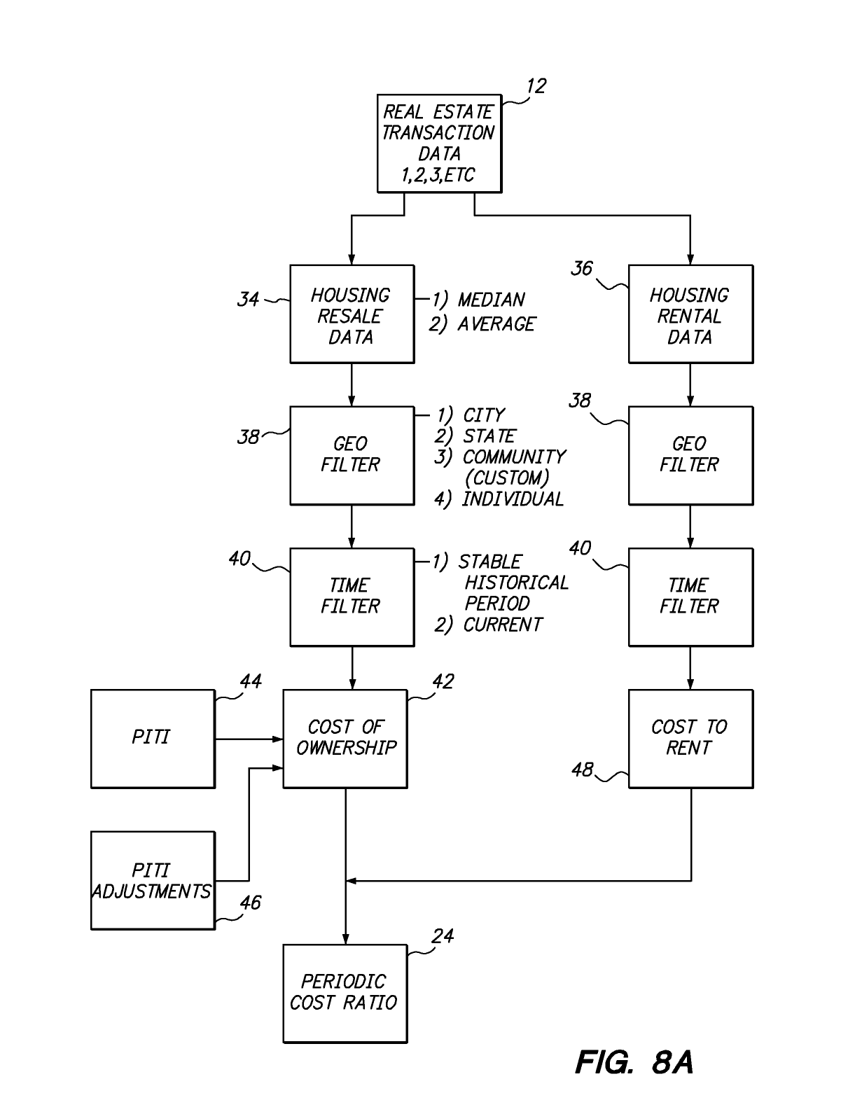

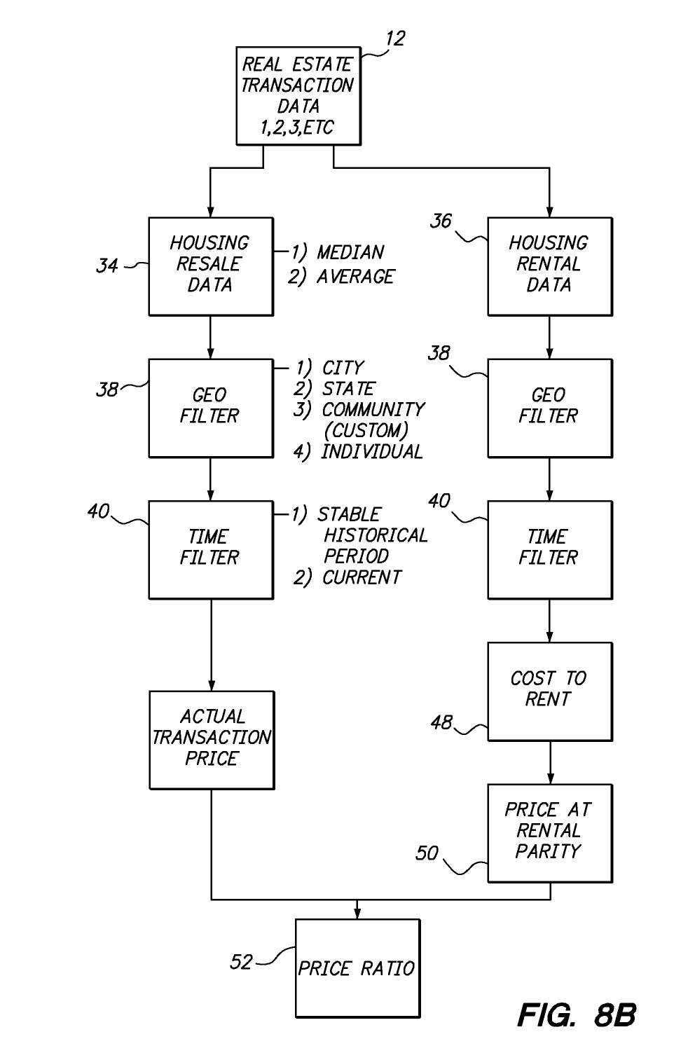

The historical premium or discount with respect to rental parity 16 may also be calculated by through price instead of monthly costs. The same process is used as shown in FIG. 8A but instead of calculating the cost of ownership 42 and the cost to rent 48, the actual transaction price (e.g., median price) based on the subset of the housing sales data 34 is compared to a rental parity price 50 (see FIG. 8B). The actual transaction price may be the median price but the average price may also be calculated. The price at rental parity or rental parity price is the value of the property or market of a geographic region based on the assumption that cost to rent equals cost to own. In other words, rental parity price answers the question of how much would the real property have to be purchased for so that the cost to rent equals the cost to own. It uses the present value of an annuity calculation applied to the rental rate. The following formula computes rental parity value over a period of n months at a monthly interest rate of c. Rental parity price=rent×[(1−(1+c)ⁿ)÷c]×Adjustment Factor. [If the quoted rate is 6%, for example, c is 0.06 divided by 12 or 0.005].

The purpose of the rental parity value is to determine the price of a house assuming that the cost of ownership of that house is equal to the cost to rent. The rental parity value may also take into consideration the adjustment factor.

The cost ratio and the price ratio should be the same. However, the adjustments 46 to PITI 44 amount to about 6% of the price of the home when calculating from the market rent. As such, the adjustment factor increases the price of the home to account for one or more of the adjustments to PITI 44.

The cost ratio 24 and the price ratio 26 may be calculated for the current market for the same geographical region as applied to the geo filter 38. This will allow a comparison of the current premium 18a, 28a or discount 20a, 30a to the historical norm calculated above to determine whether a particular geographical region is transacting above or below historical premiums or discounts. Moreover, the cost ratio 24 and price ratio 26 may be calculated for a particular individual property and compared to the cost ratio 24 or price ratio 26 for the geographical region within which the particular individual property is located. This will allow comparison of the premium 18a, 28a or discount 28a 38a of the particular individual property to determine whether a particular individual property is transacting above or below historical premiums or discounts and/or whether it would be beneficial to buy or sell a property at a particular price.

The period of time to calculate the current market may include real property transaction data 12 for the past 1 to 6 months, and preferably includes data only for the past 1 to 3 months or the past month calculated on a monthly interval.

Referring now to FIG. 4, a graph is provided which plots the median sales price of homes 54 within the city of Irvine, California from March 2012 to February 2013. Additionally, the rental parity value 56 is also reflected. P=[PV(c, n, Rent)×Adjustment Factor] where c is usually divided by 12 and n is multiplied by 12 to return a monthly cost of ownership. Additionally, the median or average price of homes within the geographical region based on current market rent and stable historical premiums and discounts for the stable period of time 22 is represented by line 58. In other words, in the Irvine market, for the period reflected in the graph shown in FIG. 4, the homes are selling for less than rental parity value. This means that it would cost less to own than to rent in this market. More importantly, since the median sales price 54 is lower than the price as a function of market rents and historical premium above rental parity, the Irvine market is transacting below historical norms. The assumption would be that the Irvine market will appreciate up to the price line 58 representing rental parity value and may overshoot that price in the future.

Referring now to FIG. 5, a graph is provided which plots monthly rents as a function of time within the city of Irvine, Calif. from March 2012 to February 2013. The actual market rent is reflected by line 60. The cost to own is represented by line 62 and is calculated from the median sales price. It is also contemplated that average sales price may be used. Additionally, line 64 represents the monthly cost to own based on the cost ratio for a stable period of time and current market rent.

### REAL PROPERTY MARKET TIMING RATING SYSTEM

The relative value of a home is an important piece of information in timing the purchase and sale of real property. However, the trends are also important. Markets where either rent or resale prices are trending downward are less desirable than markets showing positive price momentum. However, if either resale prices or rents are rising too fast then that becomes a problem as well.

The following provides a real property market timing rating system. Real property markets exhibit strong seasonal patterns and a strong tendency to trend for long periods. A way to gain an accurate understanding of what is happening in the market is to ignore the month-to-month fluctuations and focus on year-over-year changes.

It is preferable to examine data on a per square foot basis to determine the direction of pricing. The median sales price is susceptible to fluctuations based on the changes mixed with the properties being sold. Sometimes, more expensive properties are being sold which would increase the median, whereas, at other times, lower end condos are being sold which would lower the median price. As such, the price per square foot cost provides a more accurate picture of what buyers are obtaining for their money.

There are four data points within each geographical region required to calculate the year-over-year percentage change to apply the rating system. The four data points include the dollars per square foot resale, median resale home price, dollars per square foot rental, and median rental rate. Historical data for each of these four data points is required within each geographical region to complete the analysis.

### Applying Relative Value: A Real Estate Market Timing Rating System

Relative value is one of the most important features of timing the purchase and sale of real property. However, it is not the only important guide. Markets where either rents or resale prices are trending downward are less desirable than markets showing positive price momentum. However, if either resale prices or rents are rising too fast, that becomes a problem as well.

### Year-Over-Year Percentage Change

Real estate market exhibits strong seasonal patterns and a strong tendency to trend for long periods. The only way to gain an accurate understanding of what's happening in the market is to ignore the month-to-month fluctuations and focus on year-over-year changes.

### Per-Square-Foot Basis

It's preferable to examine data on a per-square-foot basis to determine the direction of pricing. The median is too susceptible to fluctuations based on the change of mix to be reliable. Looking at per-square-foot costs provides a more accurate picture of what buyers are obtaining for their money.

### Data Required

There are four data points within each geographical area required to calculate the year-over-year percentage change to apply to the rating system:
(1) Dollars-per-square-foot ($/SF) resale
(2) Median resale home price
(3) Dollars-per-square-foot ($/SF) rental
(4) Median rental rate

Historical data for each of these four measures within each area is required to complete the analysis.

### System Rating

The system uses the three key variables: valuation, resale price change, and rental price change. The system rating is the sum of these three variables subject to a maximum value of 10 and a minimum value of 1.

Market Rating 32 Market Valuation Rating+Resale Rating+Rental Rating

Property Rating=Property Valuation Rating+Resale Rating+Rental Rating

If Rating>10, then Rating=10

If Rating<1, Then Rating=1

### Resale Rating

Resale price momentum is given the least weight of the three factors. The system examines year-over-year changes rather than the monthly noise subject to seasonal variations. Is it based on the computed year-over-year change in resale dollars-per-square-foot ($/SF) price utilizing the average of the last six month's data. The $/SF measure is used to eliminate the distortions caused by a changing mix of properties that impacts median resale price.

Year-over-Year Resale Percentage Change=(Average of Previous Six Month's $/SF−Average of Previous Six Month's $/SF from One Year Ago)÷Average of Previous Six Month's $/SF from One Year Ago

When rating the Year-over-Year Resale Percentage Change, there are four categories:
If Year-over-Year Resale Percentage Change≧7%, then Resale Rating=2,
If Year-over-Year Resale Percentage Change≧2% and <7%, then Resale Rating=3,
If Year-over-Year Resale Percentage Change≧−5% and <2%, then Resale Rating=1,
If Year-over-Year Resale Percentage Change≧−5%, then Resale Rating=0,

A stable rate of appreciation is between 2% and 7%, and markets in this range get three rating points. This provides some room for minor fluctuations and recognizes that slow, sustained price increases are a normal function of healthy real estate markets.

Prices rising more than 7% per year are not sustainable; therefore, this receives two rating points rather than three.

Prices that are either rising slowly or falling slowly (between 2% and −5%) represent a weak market and receive one rating point.

Real estate markets typically display strong price momentum, a market falling in price by more than 5% per year is likely to continue to fall for the foreseeable future. Such markets may present good opportunities today, but the opportunities will be even better tomorrow. For that reason, these markets score no rating points.

### Rental Rating

Next to valuation, momentum in rents is the most important determinant of good timing in a real estate market. Rents are the basis of all value. Falling rents are a huge detriment to a housing market. In a market with falling rents, it makes little sense to buy and lock in a fixed cost of ownership unless the discount is very attractive.

Year-over-Year Rental Percentage Change=(Average of Previous Six Month's $/SF−Average of Previous Six Month's $/SF from One Year Ago)÷Average of Previous Six Month's $/SF from One Year Ago

When rating the Year-over-Year Rental Percentage Change, there are five categories:
If Year-over-Year Rental Percentage Change≧7%, then Rental Rating=3,
If Year-over-Year Rental Percentage Change≧2% and <7%, then Rental Rating=4,
If Year-over-Year Rental Percentage Change≧0% and <2%, then Rental Rating=2,
If Year-over-Year Rental Percentage Change≧−2% and <0%, then Rental Rating=1,
If Year-over-Year Rental Percentage Change<−2%, then Rental Rating=0,

Note that all rental ratings are generally higher than resale price momentum ratings. This recognizes their greater relative importance.

Similar to resale price momentum, rental rates increasing between 2% and 7% are normal and sustainable yielding a rating of four. This provides room for minor fluctuations. Rents increasing more than 7% per year are not sustainable and the rating drops to a three. Rising rents are always better than falling rents, so increases between 0% and 2% are given two ratings points. Slowly falling rents, ranging from 0% to −2%, are given one point, and rents falling more than 2% per year are given no points.

### Valuation Rating for Markets

For each property or market, the relative valuation is determined and compared to its historic norm. For each increment of 7%, the rating is either increased or decreased by one. The system assigns at least one positive rating point for any property or market that is less than 7% overvalued.

Market Valuation Rating=(Current Premium or Discount for Markets−Historic Premium or Discount)*100÷7 (rounded down to the nearest whole number)+1

In Microsoft Excel the formula is Valuation Rating=Rounddown((Current Premium or Discount for Markets−Historic Premium or Discount)*100÷7,0)+1

Current Premium or Discount for Markets=(Median Home Sales Price−Rental Parity)÷Median Home Sales Price (as defined in a previous section).

### Valuation Rating Individual Properties

The same basic calculations are performed on both market data and in the case of relative value, on individual properties. When rating individual properties, the resale rating and rental rating is used from the area within which the property is located. Therefore, the overall market data and rating is required to rate any individual property.

The valuation rating for individual properties differs from the market rating by the substitution of a different input.

For each property, the relative valuation is determined and compared to its historic norm. For each increment of 7%, the rating is either increased or decreased by one. The system assigns at least one positive rating point for any property or market that is less than 7% overvalued.

Property Valuation Rating=(Current Premium or Discount for Individual Properties−Historic Premium or Discount)*100÷7 (rounded down to the nearest whole number)+1

In Microsoft Excel the formula is Valuation Rating=Rounddown((Current Premium or Discount for Individual Properties−Historic Premium or Discount)*100÷7,0)+1

Current Premium or Discount for Individual Properties=(Property Cost Basis−Rental Parity)÷Property Cost Basis (as defined in previous section).

### Interpreting Rating

The 1 to 10 rating system was selected because most people have an intuitive understanding of it. Ten is good. One is bad.

The system is set up to yield a rating of 6 or 7 under normal market conditions. A market must become undervalued to achieve a rating of 8 or better. A rating of 4, 5, or 6 generally accompanies a weaker or more marginal market. A rating of 3 or less is either a very weak market or an extremely overvalued one.

The rating system may be automatically generated by downloading data from the data feed sources 12 to the server 10. The server 10 computes and assigns the ratings. The rating system may be displayed in a tabular format with a listing of geographical regions (e.g., state, county, city, etc.).

The rating system may be implemented by downloading the data from data feed sources 12 to a server 10. The server 10 may have software loaded thereon to complete the calculations detailed provided above and present the trending data in a tabular format. By way of example and not limitation, FIG. 4 illustrates the rating system being presented to users in the rating column. The column reflects the change in rating over a period of one year on a monthly basis. The rating system may be presented to end users through a documentation (e.g., housing report), internet website, pdf, etc.

### Search Functions

Multiple listing services that display homes for sale include various search functions. The search functions filter homes based on price, square footage, year built, number of bathrooms, number of bedrooms, etc. However, the various costs associated with any particular piece of real property varies based on factors such as Mello-Roos, homeowners association fees, property taxes as well as other factors discussed above. As such, although two homes priced at $250,000 might be shown to an Internet user, the Internet user may only be able to afford one of those two homes based on the particular costs associated with those homes. Accordingly, a search function based on income requirements is provided. A website may ask the Internet user one or more questions such as income levels, desired monthly housing costs, down payment, rating and relative value. Based on these factors, the search function may present homes that meet these requirements. By way of example and not limitation, the income requirement of the home may be calculated from PITI 44 as previously discussed above. In particular, the user would include his or her income plus the type of financing that he or she desires, namely, conventional, FHA or investor. To calculate the conventional income requirement, the PITI 44 of the particular property is calculated and divided by 0.31 times 12.

The above description is given by way of example, and not limitation. Given the above disclosure, one skilled in the art could devise variations that are within the scope and spirit of the invention disclosed herein, including various ways of integrating the various aspects into a real estate website. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer for downloading housing data and manipulating the housing data for presentation to the end user, the computer comprising:
an input port for connection to one or more housing data sources;
an output port for connection to present the manipulated housing data to the one or more end users;
a processor with software loaded thereon for performing the following steps:
determining a first ratio between a cost to own versus a cost to rent for a first time period, the determining the first ratio includes the steps of:
downloading housing sales transaction data;
filtering the downloaded housing sales transaction data based on a geographic limitation and the first time period;
calculating the cost of ownership based on the filtered housing sales transaction data;
downloading rental transaction data;
filtering the downloaded rental transaction data based on the geographic limitation and the first time period;
calculating the cost to rent based on the filtered rental transaction data;
calculating a first cost ratio based on the calculated cost of ownership and the calculated cost to rent;
presenting the first ratio to the end user.

2. The computer of claim 1 wherein the processor further includes the steps of:
determining a second ratio between a cost to own versus a cost to rent for a second time period, the determining the second ratio includes the steps of:
downloading housing sales transaction data;
filtering the downloaded housing sales transaction data based on a geographic limitation and the second time period;
calculating the cost of ownership based on the filtered housing sales transaction data;
downloading rental transaction data;
filtering the downloaded rental transaction data based on the geographic limitation and the second time period;
calculating the cost to rent based on the filtered rental transaction data;
calculating a second cost ratio based on the calculated cost of ownership and the calculated cost to rent;
presenting the second ratio to the end user.

3. The computer of claim 2 wherein the first time period is a time period more than 1 year ago and the second time period is a time period less than 1 year ago.

4. The computer of claim 3 wherein the steps of calculating the cost of ownership includes calculating PITI and adjustments to PITI.

5. A computer for downloading housing data and manipulating the housing data for presentation to the end user, the computer comprising:
an input port for connection to one or more housing data sources;
an output port for connection to present the manipulated housing data to the one or more end users;
a processor with software loaded thereon for performing the following steps:
determining a first ratio between sales transaction data versus price at rental parity for a first time period, the determining the first ratio includes the steps of:
downloading housing sales transaction data;
filtering the downloaded housing sales transaction data based on a geographic limitation and the first time period;
calculating the sales transaction data based on the filtered housing sales transaction data;
downloading rental transaction data;
filtering the downloaded rental transaction data based on the geographic limitation and the first time period;
calculating the price at rental parity base on the filtered rental transaction data;
calculating a first price ratio based on the calculated cost of ownership and the calculated cost to rent;
determining a second price ratio between a cost to own versus a cost to rent for a second time period, the determining the second ratio includes the steps of:
downloading housing sales transaction data;
filtering the downloaded housing sales transaction data based on a geographic limitation and the second time period;
calculating the cost of ownership based on the filtered housing sales transaction data;
downloading rental transaction data;
filtering the downloaded rental transaction data based on the geographic limitation and the second time period;
calculating the cost to rent based on the filtered rental transaction data;
calculating a cost ratio based on the calculated cost of ownership and the calculated cost to rent;
presenting the first and second ratios to the end user.

6. A method for searching for real estate properties, the method comprising the steps receiving a plurality of first inputs regarding personal information of an internet user;
receiving a plurality of second inputs regarding real estate criteria on desired real estate properties;
calculating a cost to own for each individual property within a real estate data set;
associating the cost to own to each individual property;
calculating an affordability level of the internet user based on the first inputs;
filtering the data set of real estate properties to only those properties that match the second inputs and the affordability level of the internet user;
presenting the filtered data set of real estate properties to the user through a website.

7. The method of claim 6 wherein the personal information includes one or more income, expenses, assets and loan type.

8. The method of claim 6 wherein the real estate criteria includes one or more of square footage, lot size, number of bedrooms, view, location, number of baths, parking, year built, garage and property type.

9. The method of claim 3 wherein the cost to own is calculated by computing PITI and adjustments to PITI.

10. The method of claim 6 wherein the affordability level takes into account a desired loan type including one or more of FHA, 30 year fixed, adjustable rate mortgage.

11. A method for rating real estate, the method comprising the steps of:
downloading real estate transaction data for rental and resale of real estate properties;
assigning a market valuation rating based on real estate transaction prices for a current market compared to real estate transaction prices for a predetermined historical period of time;
assigning a resale rating based on a rate of rising or falling prices of real estate properties;
assigning a rental rating based on a rate of rising or falling rents;
summing the calculated market valuation rating, resale rating and rental rating;
presenting the summed ratings to an internet user via a website, paper document, electronic document or email.

12. The method of claim 11 wherein the assigning the market valuation rating step includes the steps of:
calculating a premium or discount of resale prices of real estate properties compared to rental parity for the predetermined historical period of time;
calculating a premium or discount of resale prices of real estate properties compared to rental parity for the current market; and
assigning the market valuation rating based a difference between the calculated premiums or discounts for the predetermined historical period of time and the current market.

13. The method of claim 11 wherein the assigning the resale rating step includes the steps of:
calculating a year-over-year change in resale dollars-per-square-foot price utilizing an average of a prior six month's data;
assigning the resale rating based on the calculated resale year-over-year change.

14. The method of claim 11 wherein the assigning the rental rating step includes the steps of:
calculating a year-over-year change in rental dollars-per-square-foot price utilizing an average of a prior six month's data;
assigning the rental rating based on the calculated rental year-over-year change.

15. The method of claim 11 wherein the real estate transaction data is for a particular state, city, community or custom geographical region.
